(19) United States
(12) Patent Application Publication
(10) Pub. No.: US 2018/0225408 A1
(43) Pub. Date: Aug. 9, 2018

(54) SYSTEM AND METHOD FOR INTERACTIVE MODELING AND ANALYSIS OF 3-D DIGITAL ASSEMBLIES

(71) Applicant: Ignitor Labs, LLC, Schaumburg, IL (US)

(72) Inventors: Jason Anthony Ziolo, Crystal Lake, IL (US); Ryan Lee Uttech, Schaumburg, IL (US); Jason Lee Steenbarger, Crystal Lake, IL (US); Chad Hufford, Crystal Lake, IL (US)

(21) Appl. No.: 15/423,874

(22) Filed: Feb. 3, 2017

(51) Int. Cl. G06F 17/50

(52) U.S. Cl. CPC G06F 17/5086

(57) ABSTRACT

A system and method for interactive modeling of a 3-D assembly and selection and ordering of a replacement component within that assembly includes the steps of receiving, using a computer, a user selection of an assembly, providing a 3-D model of the assembly on a display of the user's computer, receiving user inputs to examine the assembly or one of its components, receiving a user selection of one or more components within the assembly, displaying information concerning each selected component, receiving an order request, and ordering a replacement component based on the order request. In certain aspects, the providing step includes receiving source materials, cleaning 3-D data files included in or derived from the source materials, organizing the cleaned-up geometry, refining the data files, building a configuration file, and deploying the refined data files and the configuration file.

### BACKGROUND

### 1. Field of the Invention

The present application is directed to interactive 3-D modeling and viewing systems.

### 2. Description of the Related Art

Technicians tasked with repairing industrial equipment often rely on paper or online parts catalogs to look for and order replacement parts. Those catalogs generally list parts by the equipment in which they are used and may even organize them by category, but they do not provide any context for the manner in which each part physically relates to other parts in the equipment as a whole. As such, the technician may be forced to examine each part in the catalog in the vacuum and may not know if a certain part is a precise match for a part in need of replacement. For example, a piece of equipment may use three different fans for different applications, and it may not be apparent from looking at a catalog whether the particular fan being viewed is a match for the one needing replacement.

Additionally, paper catalogs may be cumbersome and inconvenient to take from worksite to worksite. Thus, a technician may choose not to bring them to a particular job, in which case the catalogs are not readily accessible to cross-reference against the assembly being repaired, which may lead to incorrect part ordering. Additionally, the technician may wait until returning to an office or other location where the catalogs are stored before placing an order, potentially increasing the time required for receipt of the replacement part and, relatedly, the time that the equipment is unusable.

At the same time, 3-D modeling software is available to view assemblies and the way in which their constituent parts fit together, but that software traditionally is used at a design stage, prior to production and sale. That software also may require significant use of the computer's processing power to render and manipulate images, leading to longer load times for assemblies with multiple components.

What are needed are a system and method that address one or more of these challenges.

### BRIEF SUMMARY

In one aspect, a system and method for interactive modeling of a 3-D assembly and selection and ordering of a replacement component within that assembly includes the steps of receiving, using a computer, a user selection of an assembly, providing a 3-D model of the assembly on a display of the user's computer, receiving user inputs to examine the assembly or one of its components, receiving a user selection of one or more components within the assembly, displaying information concerning each selected component, receiving an order request, and ordering a replacement component based on the order request.

Inputs to examine the assembly or one of its components include at least one of panning, rotating, and exploding. In addition, the displaying step may include displaying one or more of a component name, one or more unique component identifiers, a description of the component, and purchasing information for a replacement component. Moreover, the ordering step may include: linking to one or more databases or websites, verifying availability of the replacement component, transmitting billing and shipping information, and completing a purchase transaction.

In another aspect, the system and method may include receiving source materials, cleaning 3-D data files included in or derived from the source materials, organizing the cleaned-up geometry, refining the data files, building a configuration file, and deploying the refined data files and the configuration file. The method also may include testing the refined data files in combination with the configuration file and additional cleaning of the 3-D data files between the refining step and the building step.

In either or both aspects, the source materials may include a 3-D model or 2-D CAD files of the assembly.

The cleaning step may include removing one or more extraneous elements from the assembly. The cleaning step also may include applying a baseline texture to all surfaces of a component, with the same texture being applied to multiple component surfaces.

The organizing step may include applying unique names to files representing each component. The organizing step also may include designating one or more components as at least one of: a featured part, an animatable part, and a hideable part. The designating step may include modifying a filename assigned to each component to apply a common convention related to the applicable designations.

The refining step may include at least one of smoothing, and texturizing (including colorizing). The refining step also may include at least one of normal mapping, alpha mapping, and bump mapping. Refined data files then may be exported into JSON and/or HTML for rendering.

### BRIEF DESCRIPTION OF THE SEVERAL VIEWS OF THE DRAWINGS

FIG. 1 is one depiction of a method of generating and implementing an interactive 3-D part modeler and reordering system.

FIG. 2 is one depiction of a method of creating and optimizing part files for deployment within the interactive system.

FIG. 3 is one example of a 3-D model of an assembly using raw geometry, after some initial cleaning and rescaling of one or more components.

FIG. 4 is a 3-D model of the assembly of FIG. 3 after having its geometry further cleaned and partially rebuilt.

FIG. 5 is a 3-D model of the assembly of FIG. 4 after having additional surfaces removed and refinements applied.

FIG. 6 is one example of a user interface for viewing and manipulating a 3-D model of an assembly and for selecting one or more parts for reordering.

FIG. 7 is another example of the user interface of FIG. 6, depicting the assembly without exterior panels.

FIG. 8 is yet another example of the user interface of FIG. 6, showing rotation of the assembly.

FIG. 9 is still another example of the user interface of FIG. 6, depicting selection of a specific component of the assembly and display of relevant information regarding that component.

FIG. 10 is another example of the user interface of FIG. 6, depicting isolation of the specific component selected in FIG. 9.

FIG. 11 is yet another example of the user interface of FIG. 6, depicting the assembly in an exploded view.

FIG. 12 is one depiction of the architecture of a 3-D part modeler and reordering system.

### DETAILED DESCRIPTION

With reference to the figures, a method and system for 3-D modeling of an assembly and its constituent components is provided. In one aspect, the system may be particularly useful to technicians tasked with repairing industrial equipment, e.g., kitchen equipment, HVAC equipment, assembly line equipment, etc., although it also may be used for modeling of any assembly that includes one or more replaceable components. The system also may be configured to provide a process for interactive ordering of one or more replacement components that is triggered by selecting the component from a 3-D model of the assembly.

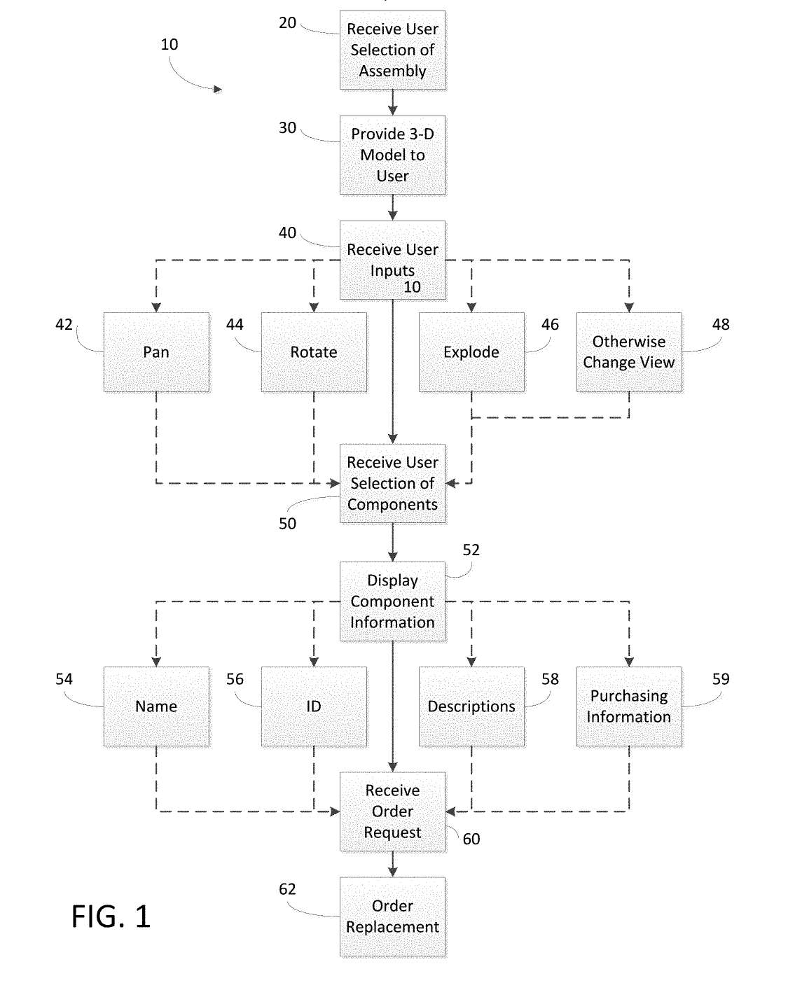

As seen in FIG. 1, the method 10 may include receiving 20 a user selection of an assembly, providing 30 a 3-D model of the assembly on a display of a user's computer, receiving 40 user inputs to examine the assembly or one of its components, which may include panning 42, rotating 44, exploding 46, or otherwise changing 48 the view of the assembly or component, receiving 50 a user selection of one or more components within the assembly, displaying 52 information concerning each selected component, including, e.g., a component name 54, one or more unique component identifiers 56, a description 58 of the component, and/or purchasing information 59 for a replacement component, receiving 60 an order request, and ordering 62 a replacement component based on the order request. The ordering step 62 may include linking to one or more databases or websites, verifying availability of the replacement component, transmitting billing and shipping information, and completing a purchase transaction.

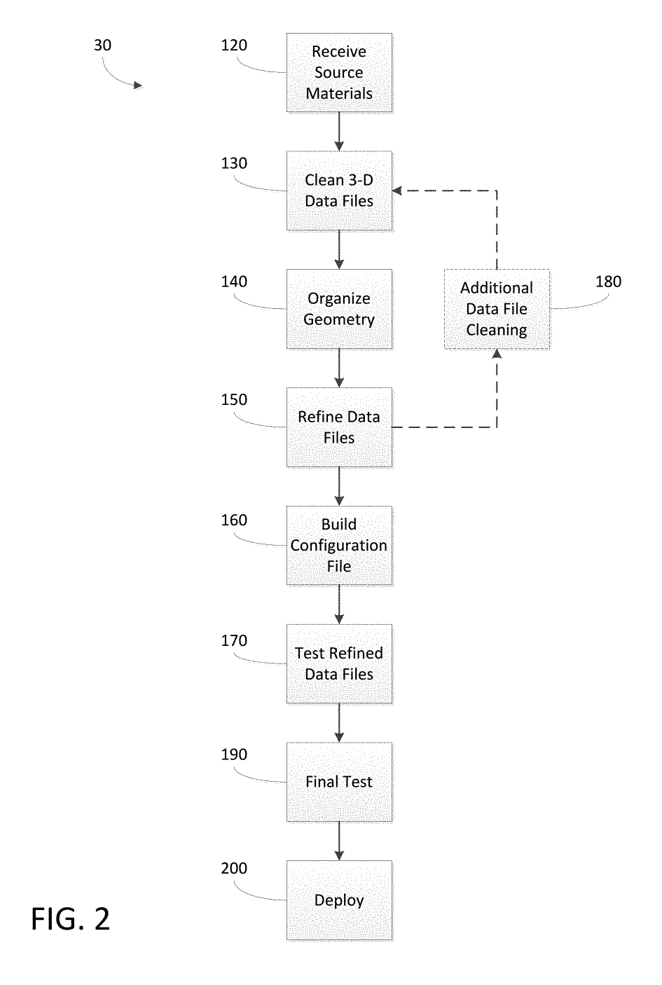

In one aspect, the providing step 30 may include retrieving a detailed 3-D model, such as an OEM model, from a data repository and presenting that model to the user via the display. It may be desirable to simplify the 3-D model to reduce file size, thereby reducing processing time and reducing a processing load on the user's computer. Thus, as seen in FIG. 2, the providing step 30 may generally include the steps of receiving 120 source materials, cleaning 130 3-D data files included in or derived from the source materials, organizing 140, e.g., naming, the cleaned-up geometry, refining 150 the data files, building 160 a configuration file, and testing 170 the refined data files in combination with the configuration file. In one aspect, the method may include optional additional cleaning 180 after the refining step 150 and before proceeding to the building step 160. The method 10 further may include final testing 190 and, ultimately, deployment 200.

The receiving step 120 may include obtaining part and/or assembly data files, photographic or other image data files, part names, and part identifiers. In particular, the part and assembly data files may be OEM files including all data necessary to build an exact replica of the assembly being referenced. For example, the file may include screws, pins, rivets, or other fasteners, as well as wires, soft goods, insulation, etc. The data files may be 3-D models of the assemblies. Alternatively, the data files may be 2-D CAD files, e.g., files representing production geometry, that are readable using any standard CAD software, including those sold under the trademarks AutoCAD, SolidWorks, and Pro/ENGINEER, which the system then may convert to a 3-D format, such as .asm or .prt. In still another alternative, fewer than all component data files may be received by the system, requiring the user to model one or more aspects of the component based on other available information, e.g., photographs or physical models.

Goals of the cleaning step 130 may include reducing file size and complexity while still retaining sufficient data for accurate rendering of the parts and assemblies. Thus, the cleaning step 130 may involve removing one or more extraneous elements from the assembly. These removed elements may include, e.g., fasteners and non-essential structure. The cleaning step 130 further may include removing one or more “soft goods,” which may include insulation, hoses, plugs, wires, etc., i.e., items whose absence does not affect a user's ability to quickly identify or recognize parts within the assembly.

In addition, within the cleaning step 130, the geometry of the remaining parts/elements may be rebuilt, smoothed, or otherwise refined in order to reduce excessive geometry, i.e., an unnecessary number of polygons representing those elements, which has the potential for significantly reducing the size of the data file associated with the part or assembly. In this context, polygons are understood to be individual segments representing one way for breaking up a 3-D model into a plurality of surface elements in order to control how the model is displayed. Within this step, the method may involve evaluating whether the part is crucial to a user's understanding or recognition of the assembly. If so, the method may retain that piece in a substantially complete configuration. If not, the method may include evaluating the part to determine what surfaces can be removed or flattened, i.e., what aspects of the topology can be modified in order to reduce file size associated with the part. For example, a series of surfaces may be replaced with a single, planar surface if the substitution retains the general shape conveyed by the original series of surfaces. Similarly, a curved surface initially may be represented by a large number of small polygons, since smaller edges of those polygons may better represent the curvature of the surface. In that instance, the cleaning step 130 may include replacing those small polygons with slightly larger ones. The resulting surface may appear more segmented and less curvilinear, but the tradeoff for fewer polygons may be acceptable if the general shape is still conveyed to a user. Additionally, the effect of increased segmentation may be reduced through smoothing, texturing, or other techniques, as discussed in greater detail below.

The cleaning step 130 also may include rebuilding one or more components to depict those components more accurately. Rebuilding may be desirable when the image from the raw data file may not accurately depict the final or current iteration of the part, such as when the raw data file depicts an outdated or non-production version of the component or when elements in the raw data file do not align as intended in a production version. In some instances, rebuilding may resort in the creation of additional polygons within the 3-D model, although such a tradeoff may be deemed acceptable if it results in additional clarity being provided to the end user.

In another aspect, the cleaning step 130 additionally may include applying a baseline texture to all surfaces of a component, with the same texture being applied to multiple component surfaces. Alternatively, textures may be applied in an additional step, such as the refining step 150, as discussed below.

The organizing step 140 may include applying unique names to files representing each component, e.g., using the names provided to the components by the OEM or part supplier. Additionally, this step may include designating one or more components as a featured part or as a dynamic part, e.g., an animatable part and/or as a hideable part. This designation may be reflected in the filename assigned to each component, where a common convention may be applied to every part that has one of these designations. For example, the system may apply one or more of the following naming conventions:

Featured parts may be named: <part#><alpha>_select.<extension>

Animatable parts may be named: <part#><alpha>_anim.<extension>

Hideable parts may be named: <part#><alpha>_hide.<extension>.

This edited geometry then may be exported from its raw format into a different data format usable with a rendering engine. In one aspect, the format may be .obj or .fbx, although other data formats may be employed, as would be understood by one of ordinary skill in the relevant art.

The refining step 150 may apply additional graphical refining techniques in order to improve the appearance of an assembly or its constituent parts. For example, smoothing, texturizing (including colorizing), and other techniques may be applied to enhance the visual appearance of parts without significantly increasing the file size associated with each part or assembly. One or more graphics rendering or modeling software suites, such as the open-source software distributed under the trademark BLENDER with the rendering engine named Blend4Web, may be employed to carry out this refining step 150. Other modeling software such as the software available under the trademarks UNITY and UNREAL may be employed, as would be appreciated by one of ordinary skill in the relevant art, although it also will be appreciated that the use of other modeling software may require the installation of additional plug-ins on the end user's computer. The resulting refined 3-D objects then may be exported in a file type supporting future viewing and manipulation of those objects in a deployment architecture, e.g., JSON and/or HTML.

As described above, one or more parts may be designated as “featured,” e.g., because they are the parts for which replacements are available, or because they are the parts known to be in need of more frequent replacement. Accordingly, within the refining step 150, the method may include applying one or more visual distinguishing characteristics to those “featured” parts. In one aspect, the visual distinguishing characteristics may include shading or texturizing the external surface of the part a different color than the other parts within the assembly. For example, assembly parts may be shaded gray as part of the cleaning step 130 or of this step, while featured parts may be shaded in a green tint or another hue that is easily visually distinguished from those gray parts. Additionally or alternatively, the properties of the featured parts may be modified to permit outlining of those parts, e.g., when selected by a user in the ultimate deployment environment. Within the rendering engine, the featured parts may have their properties modified to recognize that they are selectable. Still further, one or more parts may be smoothed to modify the way that a virtual light source might be reflected off a surface. Smoothing may yield significant visual benefits, without a need to modify a large number of polygons making up a modified surface. Stated another way, smoothing and texturizing surfaces may result in an overlayment to the surfaces or the impression of such an overlayment, thereby providing significant visual detail without the need to modify the attributes of each of the dozens, hundreds, or even thousands of polygons that are used to model those surfaces.

Also as described above, the assembly may be animatable. In addition to removing or hiding elements and panning, tilting, zooming, and rotating the assembly, one or more parts may be explodable in order to give a user a better view of those component parts by themselves. As such, the refining step 150 may include defining relative end positions and pathways for the exploded parts to ensure that one or more parts do not overlap or interfere with each other while and/or after being exploded. In some instances, this process may require a multi-step animation, in which one or more first parts are exploded in order to provide clearance for one or more secondary parts to be exploded.

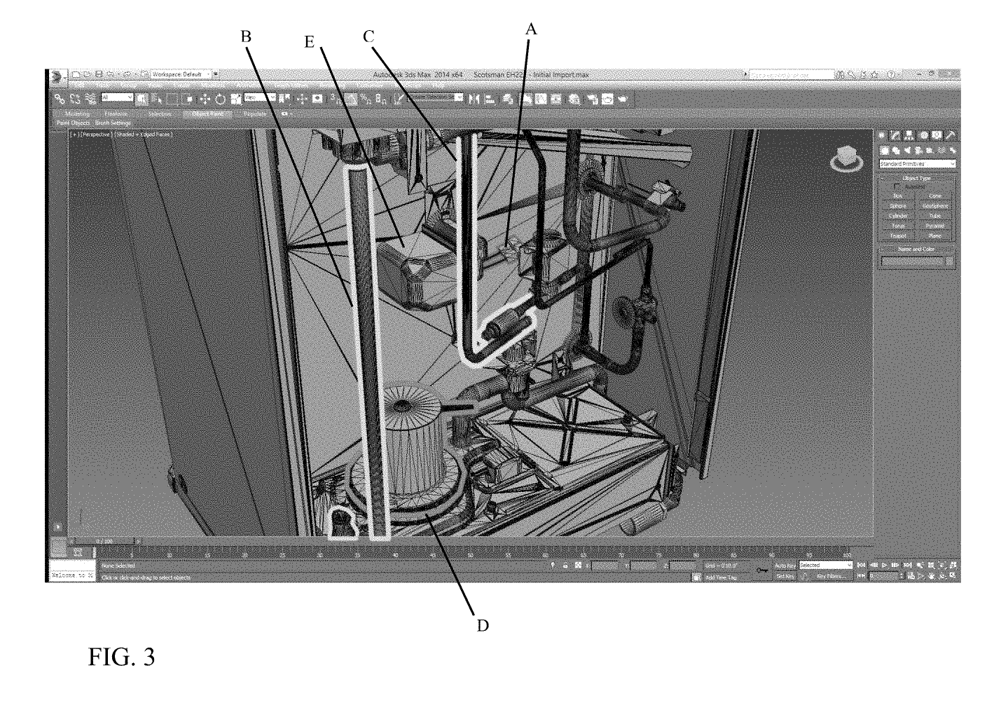

FIGS. 3-5 depict examples of the cleaning step 130 and refining step 150 being applied to an ice machine assembly. In FIG. 3, the assembly has undergone initial cleaning to ensure that components are scaled properly relative to one another. The assembly also has had several surfaces removed for simplification. For example, the external panel on the left side of the assembly may have been simplified into two large triangular surfaces instead of a multiplicity of smaller polygons. Moreover, a baseline gray texture has been applied to all surfaces.

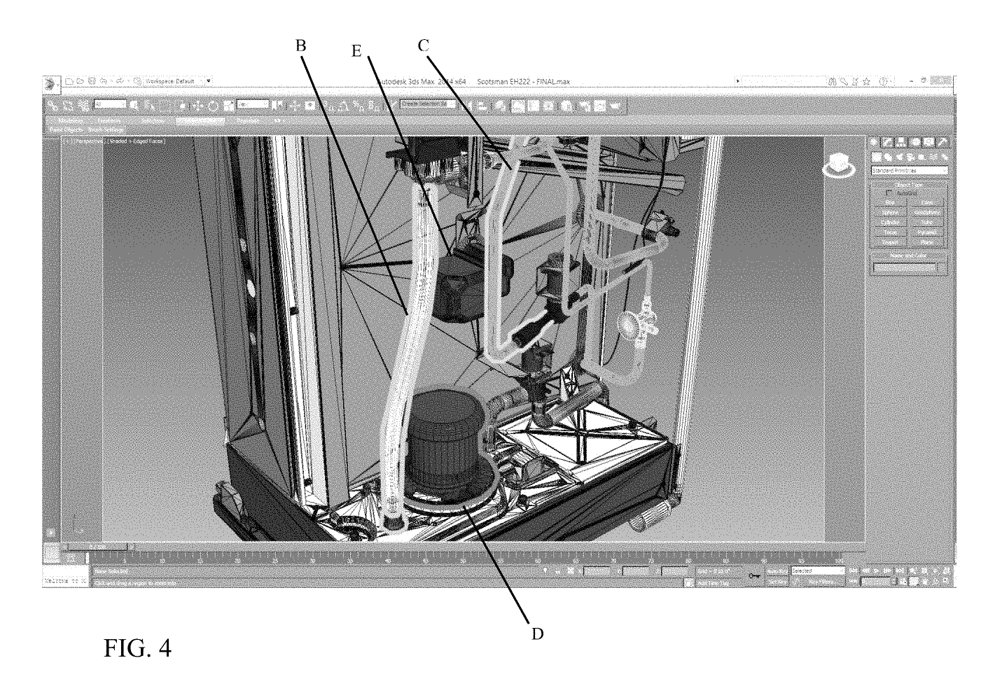

FIG. 4 depicts additional aspects of the cleaning step. In comparing FIGS. 3 and 4, it will be seen that element “A” in FIG. 3 was deemed not necessary and, therefore, was removed from FIG. 4. Additionally, the tube “B” and pipe “C” have been rebuilt to show proper connections with other parts and/or to provide the necessary clearances between components. Still further, the condenser “D” was rebuilt or had its geometry otherwise revised in order to provide the user with a more accurate depiction of that component.

As discussed above, various textures and/or mappings then may be applied to the components within the assembly to modify their appearances without increasing the number of polygons making up each component by affecting the way a virtual light source reflects off the polygons that are present. For example, mapping techniques including diffuse mapping, normal mapping, and alpha mapping may be applied to provide the appearance of additional details while keeping the number of polygons the same. As would be appreciated by one of ordinary skill in the relevant art, diffuse mapping may include applying colors or textures to the component surfaces, normal mapping may involve a visual representation of how lighting should affect a flat surface, e.g., providing depth, and alpha mapping may involve cutting holes in a 3-D model to represent areas of the model that should not include structure. Other mapping techniques, including bump mapping, specular mapping (in which lighting levels and how lighting affects certain surfaces, e.g., making them appear dull or shiny), and displacement mapping (in which polygons are actually moved relative to one another), also may be employed. As such, each image may convey more detail and a more accurate rendering of the assembly to a user, while keeping the file size and, therefore, the rendering or processing time to a minimum.

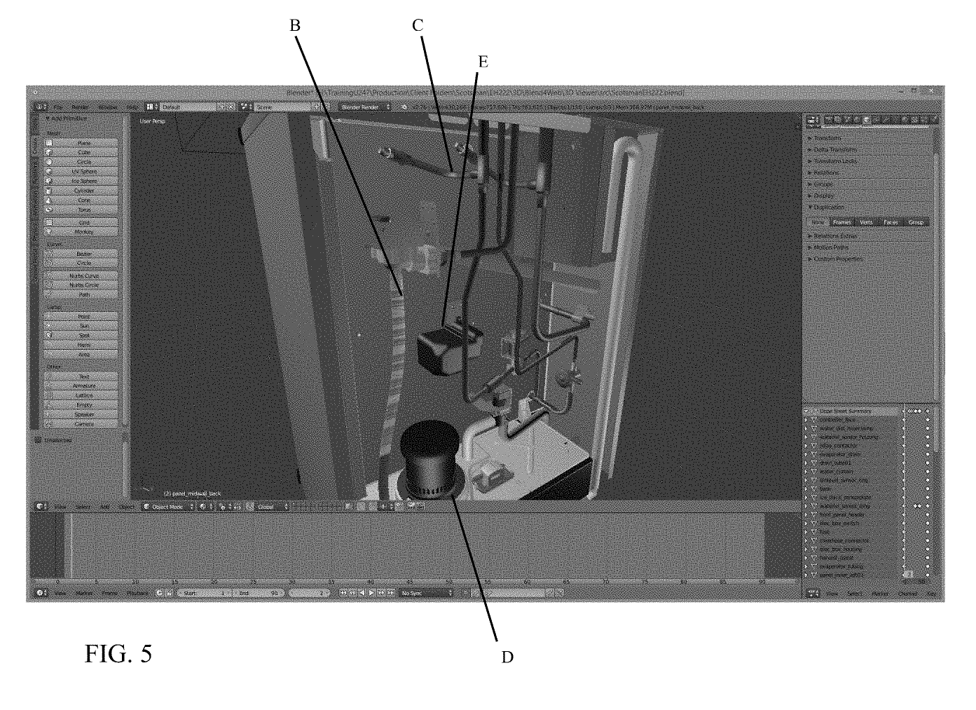

FIG. 5 depicts several of these techniques. For example, rather than edit each of the various polygons used to form component “E,” smoothing techniques are applied to approximate those changes and to estimate the way in which light would reflect off those surfaces. These techniques may include varying the materials and texture properties that are applied to various components. For example, tube “B” may be designated as a clear, plastic tube, which may result in increased reflectivity being exhibited by its exterior surface. Additionally, pipe “C” may have its attributes changed to an orange color with a metallic material property in order to approximate a copper look for the user's ease of identification.

At any point during the refining step 150, it may be determined that the process will benefit from additional cleanup. For example, the refiner may determine that additional elements can be removed or that additional surfaces can be rebuilt to further reduce the amount of data associated with the assembly. Thus, the method may include the additional cleaning step 180, which returns the system to the cleaning step 130, with that step and a revisited organizing step 140 to be completed before returning again to the refining step. The additional cleaning step 180 also may be iterated until a developer is satisfied with the level of cleaning/file size reduction.

Once the geometry of the assembly has been cleaned, organized, and refined sufficiently, the method 30 may proceed to the building step 160. In this step, the system may build a configuration file for ultimate loading into the user's viewer. The configuration file may include instructions telling the system how to display an assembly and its constituent parts, e.g., what parts are featured, animatable, hideable, etc. Additionally, the configuration file may include both instructions to display additional information to the user when a component is selected, along with that additional information itself. In one aspect, the configuration file may include part identifying information such as: an OEM number, a part number, a part name, and a description of the part. The configuration file also may be populated to include a list price and an Internet link (e.g., http:// or https://), along with instructions to display one or more components of that information when the user selects the part, thereby facilitating purchase of a replacement part. In one aspect, the system may include an “offline” configuration, in which substantially all system components are configured to work without Internet access. Thus, in addition to or instead of an Internet link, this data may be cached locally for on-demand display to the user. Subsequent purchases also may be queued for completion once an Internet connection is established.

Moreover, the configuration file may include a link to a data repository or an Internet address that includes a photograph or other depiction of the part in order to assist the user in visually confirming that the selected part matches the one desired to be replaced.

Data in the configuration file may be manually entered into either the configuration file or a database called based on instructions contained within the configuration file. In another aspect, the system may include an application program interface (API) configured to query an external source of one or more of the data categories in order to build the configuration file dynamically. The external source may include a system-hosted database. Alternatively, the external source may be outside the immediate control of the system provider, such as may be the case when the external source is the website or database of a part supplier, where the supplier does not provide other components of the system.

When building the configuration file, the system may rely on the naming conventions applied during the organizing step 140, thereby simplifying the building step 160 and ensuring greater accuracy of that resulting configuration file. For example, because all animatable parts may be provided with a filename ending in “_anim,” the system may just search for all parts with that filename snippet and designate all such parts as being animatable in the configuration file.

In one aspect, the configuration file may be written in an XML or JSON data format, although other data formats may be implemented, as would be appreciated by one of ordinary skill in the relevant art.

The testing step 170 may include verifying that each aspect of the configuration file loads and executes properly and completely. For example, all featured parts should be selectable, should display accurate and complete part information when selected, and should differentiate themselves from other parts when selected (e.g., via distinguishing coloring/shading and/or outlining). Similarly, all hideable parts should hide properly when selected or marked to be hidden or when a featured part is isolated. Moreover, all animatable parts should animate smoothly, correctly, and completely, preferably where no parts clip or overlap one another during or after the animation process.

The final testing step 190 may be similar to the testing step 170 and may serve as a double-check of the accuracy of the testing results.

In one aspect, one or both of the testing step 170 and final testing step 190 may be omitted, quickening deployment after generation of the configuration file.

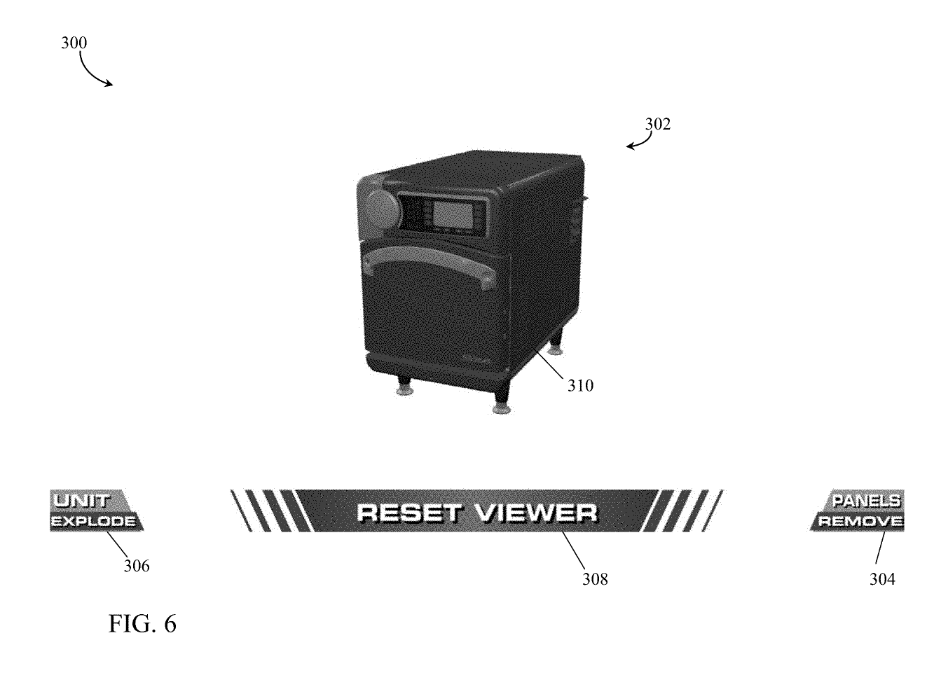

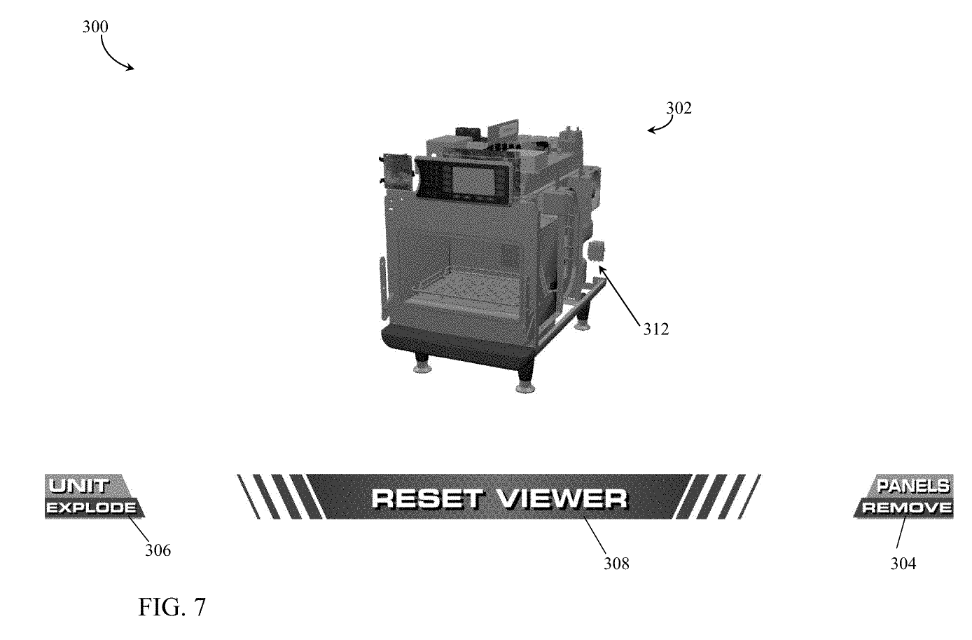

Returning now to the method depicted in FIG. 1 and described above, various aspects of the providing 30, receiving 40, receiving 50, and displaying 52 steps may be depicted in FIGS. 6-11. For example, FIG. 6 depicts one example of a user interface 300 displaying a three-dimensional rendering of a part 302 made of a plurality of components. The user interface 300 may include one or more selectors in order to modify the presented view based on an input from the user. Thus, in one example, the user interface may include one or more of a remove panel selector 304, an explode unit selector 306, and a reset viewer selector 308. Upon receiving a user input of the remove panel selector 304, the system may hide the one or more components that correspond to exterior panels or surfaces 310, thereby revealing a view of the internal components 312 of the part 302, as seen by comparing FIG. 6 with FIG. 7.

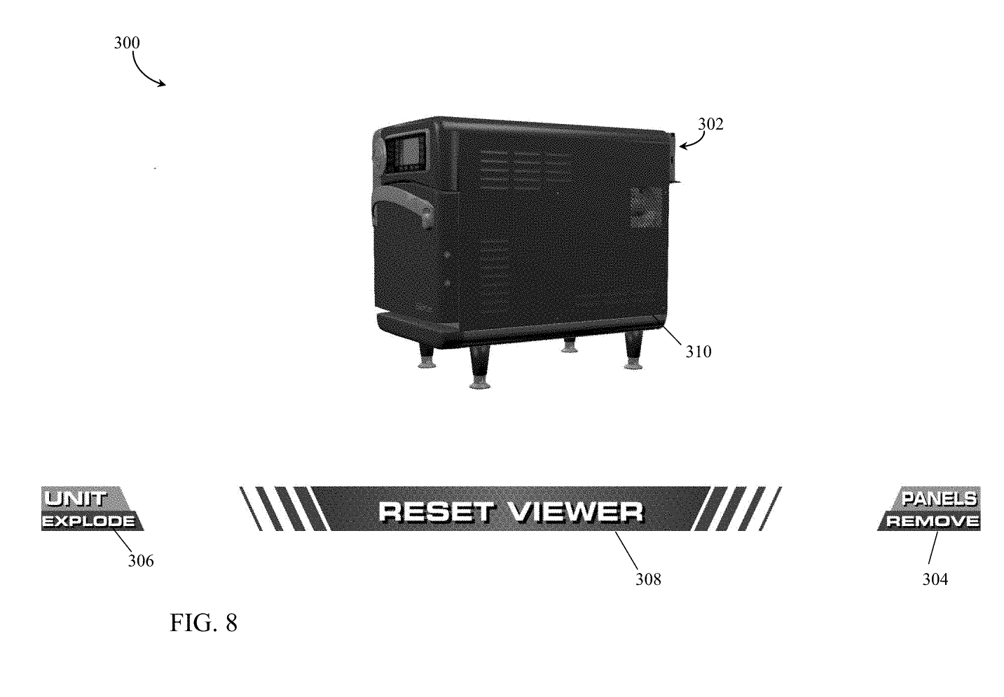

With respect to the receiving 40 step, FIG. 8 illustrates one example of the part 302 in the user interface reacting to user input, specifically to input rotating 44 the part 302. Although FIG. 8 depicts the part 302 of FIG. 6 being rotated, the system also may permit rotation of the part 302 of FIG. 7, with the panels 310 omitted.

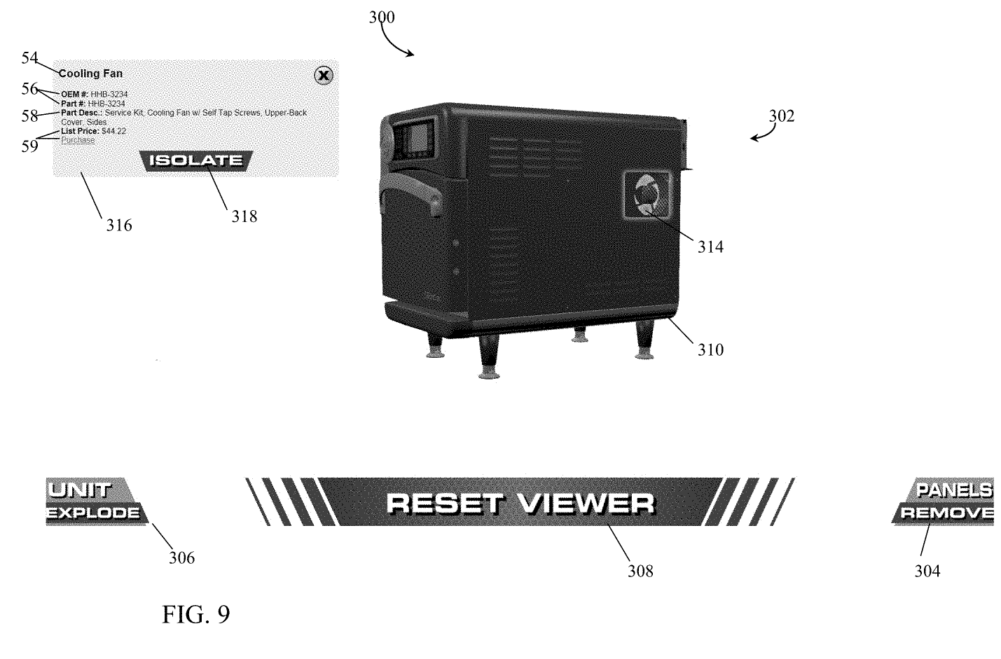

As discussed above, the method 10 may include the steps of receiving 50 a user selection of one or more components within the assembly and displaying 52 information concerning each selected component. FIG. 9 depicts an example of this user selection and subsequent information display. For example, in FIG. 9, the user selected a cooling fan 314, which caused the system to do several things. First, the system may highlight the selected item, e.g., by providing an outline or different color background around and/or behind the selected item. Second, the displaying 52 step causes relevant information 316 to be displayed within the user interface, including the part name 54, various identifiers 56, including, e.g., OEM and part numbers, a description 58, and purchasing information 59, which may include a price and a link to a website for ordering the part.

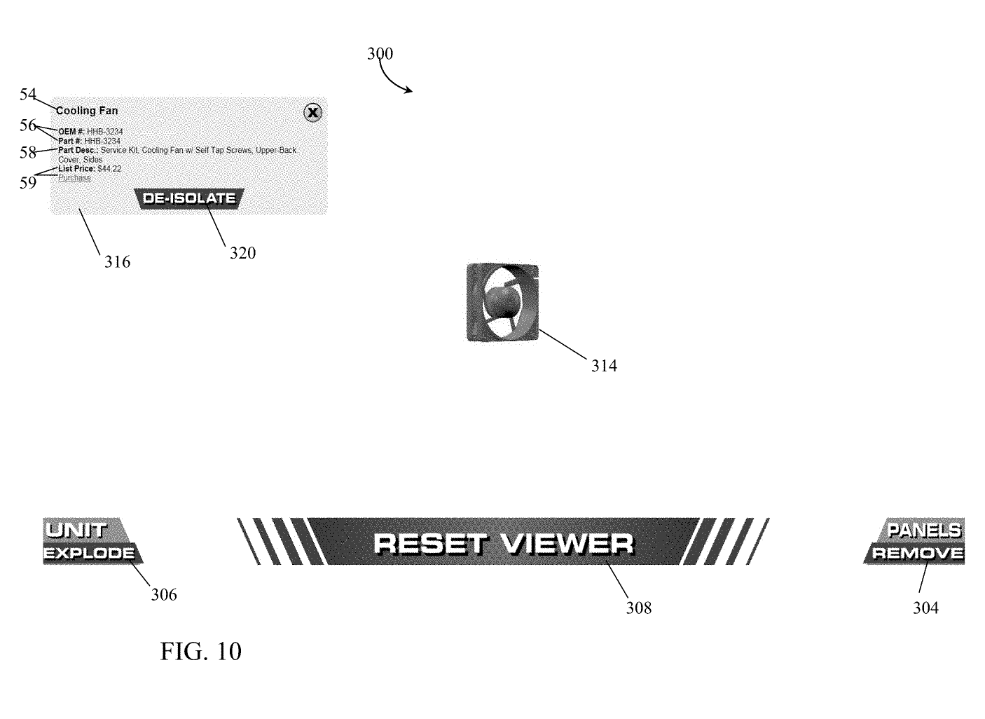

Additionally, FIG. 9 illustrates that the user interface may include an isolate part selector 318. Upon receiving a user input of that selector 318, as seen in FIG. 10, the system may remove all other components of the part 302 from display in the user interface 300, allowing the user to inspect solely the selected part in greater detail. At the same time, the system may keep displaying the part-specific information 316. FIG. 10 further illustrates that the user interface 300 may generate a de-isolate selector 320 in order to repopulate the user interface 300 with the hidden parts/components.

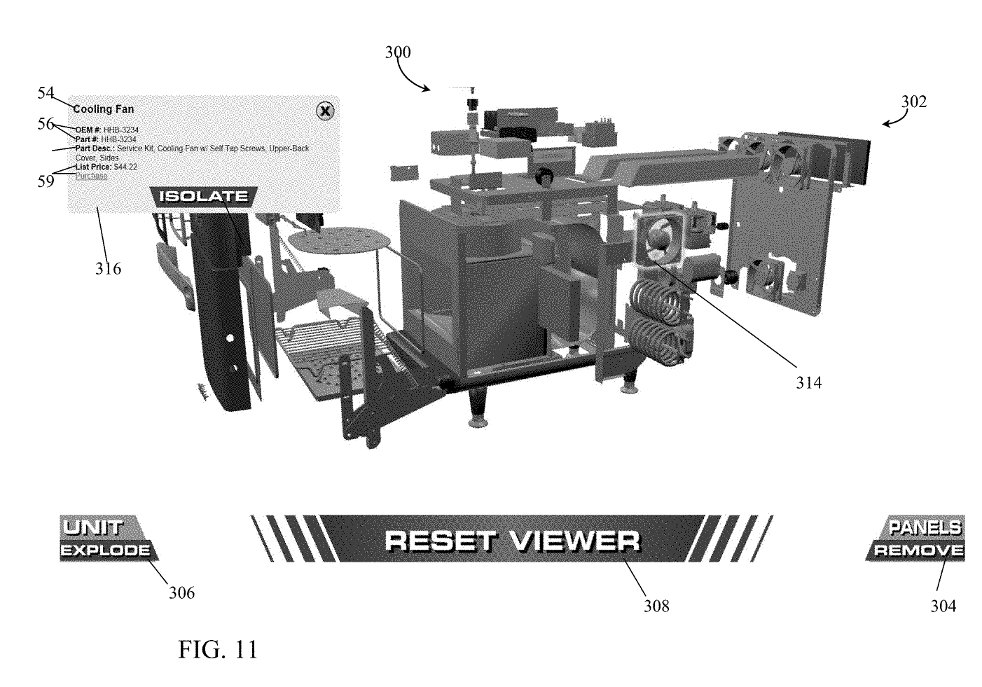

FIG. 11 shows still another aspect of the user interface 300 upon receiving 40 a user input. Specifically, FIG. 11 depicts a user input of the unit explode 306 selector in order to undertake exploding 46 the assembly into separate components. In FIG. 11, the cooling fan 314 was selected prior to the unit explode 306 selector being chosen, such that the cooling fan 314 relevant information 316 remains displayed within the user interface 300. Once exploded, the user may get a better view of the parts of the assembly, which may assist the user in selecting the proper part or parts for reviewing and replacement ordering. Other user interface functionality may remain after the assembly is exploded, e.g., the assembly or its constituent parts still may be panned, rotated, zoomed, had its exterior panels removed, etc.

At any point during manipulation, the user may use the reset viewer 308 selector, which may return the assembly to a base display configuration, such as the display configuration shown in FIG. 6

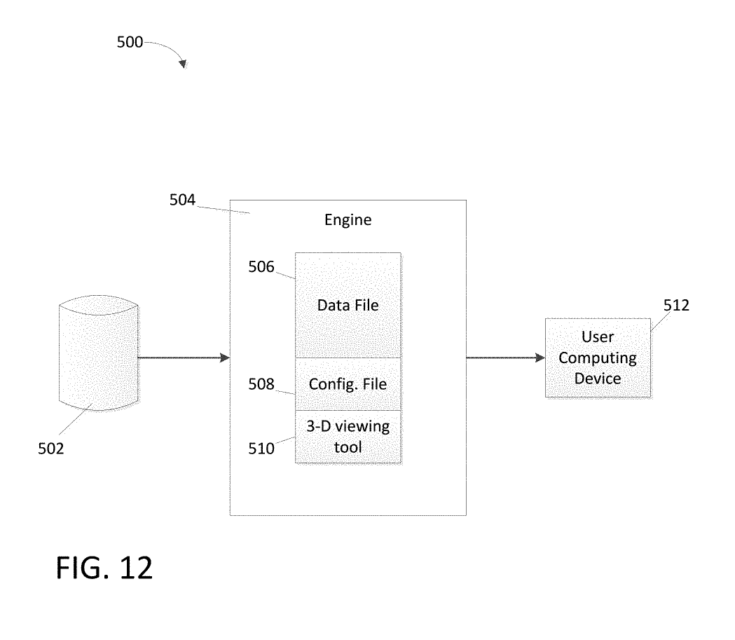

As seen in FIG. 12, the system 500 preferably is configured so that deployment can occur within an Internet browser, whether online or offline. In particular, the system may be configured for deployment in one or more different configurations. In a first aspect, the system may be deployed as a stand-alone application, available both online or offline. In the latter case, assembly or part files (having, e.g., .obj or .fbx extensions) and/or configuration files (having, e.g., .xml or .json extensions) may be stored in a compressed or uncompressed state on the user's computer. If compressed, calling up an assembly or part may result in decompression of the relevant files and loading of those files into the application.

In another aspect, the system 500 may be deployed in a standalone package, without the need for a separate plug-in or player, although such an alternative deployment may be possible, particularly depending on the requirements of the viewer that is used. The alternative deployment may result in various system components being hosted on a server separate from the user's computer, those components being linked or accessed upon demand by the user's computer. For example, the engine 504 (discussed below) may reside on the user's computer and may call a database 502, configuration file 508, and/or viewing tool 510 (also all discussed below).

In still another aspect, the system may be implemented as a thin client stored locally on the user's computer and providing the desired interactive output directly through a graphical user interface associated with the client rather than through a web browser.

In this aspect, the thin client may be an application, such as an application stored on and accessible through a mobile device such as a cellular phone, laptop, or tablet-type computer. The application may retrieve core system components including the assembly or part data files and the configuration file and store them in local memory for retrieval on-demand by the end user. In order to avoid overburdening the system, the end user may retrieve one or more parts or assemblies in advance, e.g., upon learning what kind of machine or apparatus is in need of repair, in order to download only those components necessary for analysis and to not store data files associated with other, irrelevant assemblies. This aspect may be particularly beneficial in situations where the machine or apparatus in need of repair is in a location with no, or slow, internet access, such as in an internal room within a building. In this aspect, user inputs, including requests for new or replacement parts, may be stored locally in a queue, e.g., in the device memory. The system may periodically search for an internet connection and, upon detecting such a connection, may retrieve the relevant data from the queue and carry out the necessary response, e.g., placing an order for the relevant replacement part.

In yet another aspect, the system may be embeddable within a third-party website, e.g., within the website of a part distributor. The website may include code configured to call one or more of the database 502, configuration file 508, and/or viewing tool 510 and to insert the results into dedicated real estate on that website. In this aspect, the third party website may transmit a vendor ID and unique code or employ other authentication features as would be appreciated by those of ordinary skill in the relevant art, in order for the system to verify that requests are coming from an authentic, authorized user.

Regardless of the implementation, the system 500 may include a database 502 or other data repository and an engine 504. The engine 504 may be configured to execute software instructions to carry out the cleaning step 130, refining step 150, and/or deployment step 200. In one aspect, the engine 504 may interact with at least one assembly or part data file 506, a configuration file 508, and an interactive library/3-D viewing tool 510. The engine 504 may be a virtual machine that requests or retrieves data from each of these components and, through use of the viewing tool 510, outputs an interactive, manipulable part suitable for embedding in a client browser by generating HTML5 and/or JSON code renderable using WebGL.

In one aspect, the engine 504 may be a JavaScript engine that includes code to retrieve the selected part or component file 506 from the database 502. This component file 506 may be a cleaned-up, refined data file that has had soft goods or other extraneous components removed, and surfaces simplified and/or textured to significantly reduce the file size and, relatedly, the processing time necessary to render the part. In another aspect, the component file 506 may be a raw 3D data file or a preliminary 3D style file created from other sources, as discussed above, such that the engine 504 may be used to provide the necessary cleaning and/or refining. Examples of such 3D files may include those having .3DS or .OBJ extensions, although other 3-D data types may be used, as would be understood by one of ordinary skill in the relevant art.

The configuration file 508 may include instructions informing the engine 504 of how the part and its components have been configured, e.g., which elements are featured, hideable, and/or animatable. The configuration file 508 also may include the links to component-identifying data and data necessary for reordering one or more components, or it may include a locally-cached version of that data, itself. In one aspect, the configuration file 508 may be an XML file. Alternatively, the file 508 may be a JSON or another data interchange format. The configuration file 508 may be created upon selection of the relevant part file 506 or, alternatively, it may be precompiled and stored, e.g., in the database 502 or another repository. The viewing tool 510 may receive requests from the engine 504, e.g., in the form of JavaScript calls and output the rendered image to the client browser.

Both the method of modeling a part and its components for later viewing and analysis and the method of analyzing the part and ordering one or more components may be carried out on a computing device that includes a processor, device logic, one or more input/out devices, and a display. In addition, the computing device may include a memory component, which can include many types of memory, data storage, or non-transitory computer-readable storage media, such as data stores for program instructions, images and other data, and a removable memory for sharing information with other devices, etc. One or more cameras or other image sensors may capture image or video content, e.g., to generate part models rather than relying on CAD data files. Image capture may be performed using a single image, multiple images, periodic imaging, continuous image capturing, image streaming, etc.

While a local environment completely physically contained on the computing device may be used, different distributed environments may also be used, as appropriate, to implement various aspects of the system and method. The example environment may include the computing device 512, which is operable to send and/or receive requests, messages or information over an appropriate network and, in some embodiments, convey information back to a user of the computing device 512. The network can include any appropriate network, including an intranet, the Internet, a cellular network, a local area network, a satellite network or any other network and/or combination thereof. Components used for such a system can depend at least in part upon the type of network and/or environment selected. Protocols and components for communicating via such a network are well-known and will not be discussed in detail. Communication over the network can be enabled by wired or wireless connections and combinations thereof. The example environment may further include other user devices communicatively coupled to the network. The communication network may facilitate completion of tasks by providing a connection to data stores, such as task or item data stores, that are remote from the computing device 512. Additionally, the communication network may facilitate receipt by the computing device 512 of messages or other task data from the other user devices and/or servers, as well as transmission from the computing device 512 of responses to messages, etc.

The data stores 502 can include several separate data tables, databases, data documents, dynamic data storage schemes and/or other data storage mechanisms and media for storing data relating to a particular aspect of the present disclosure. It should be understood that there can be many aspects that may need to be stored in the data store, such as user information and access rights information, which can be stored in any appropriate mechanisms in the data stores 502. The data stores 502 may be operable, through logic associated therewith, to receive instructions from the engine 504 and/or the user's computing device 512 and obtain, update, or otherwise process data in response thereto. In this case, the data store 502 might access the stored data to verify the identity of the user and can access the catalog detail information to obtain information about items of that type. The information then can be returned to the user, such as in a user interface displayed on the computing device 512.

The various embodiments can be implemented in a wide variety of operating environments, which in some cases can include one or more user computers, computing devices or processing devices that can be used to operate any of a number of applications. User or client devices can include any of a number of general purpose personal computers, such as desktop, laptop or tablet computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network. These devices also can include virtual devices such as virtual machines, hypervisors and other virtual devices capable of communicating via a network.

Various embodiments of the present disclosure utilize a network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, a satellite network, and any combination thereof.

In embodiments utilizing a web server, the web server can run any of a variety of server or mid-tier applications, including Hypertext Transfer Protocol (“HTTP”) servers, FTP servers, Common Gateway Interface (“CGI”) servers, data servers, and business application servers. The server(s) also may be capable of executing programs or scripts in response to requests from user devices, such as by executing one or more web applications that may be implemented as one or more scripts or programs written in any programming language, such as Java®, C, C# or C++, or any scripting language, such as Ruby, PHP, Perl, Python or TCL, as well as combinations thereof. The server(s) may also include database servers, including those commercially available from Oracle®, Microsoft®, Sybase®, and IBM® as well as open-source servers such as MySQL, Postgres, SQLite, MongoDB, and any other server capable of storing, retrieving, and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, a central processing unit (“CPU” or “processor”), an input device (e.g., a mouse, keyboard, controller, touch screen or keypad), and an output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a wireless or wired network card, an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within a working memory device, including an operating system and application programs, such as a client application or web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as, volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided, a person of ordinary skill in the art will appreciate other ways and/or methods to implement the various embodiments.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

We claim:

1. A method for interactive modeling of a 3-D assembly and selection and ordering of a replacement component within that assembly, comprising:
receiving, using a computer, a user selection of an assembly,
providing a 3-D model of the assembly on a display of the user's computer,
receiving user inputs to examine the assembly or one of its components,
receiving a user selection of one or more components within the assembly,
displaying information concerning each selected component,
receiving an order request, and
ordering a replacement component based on the order request.

2. The method of claim 1, wherein the providing step includes:
receiving source materials,
cleaning 3-D data files included in or derived from the source materials,
organizing the cleaned-up geometry,
refining the data files,
building a configuration file, and
deploying the refined data files and the configuration file.

3. The method of claim 2, wherein the source materials comprise a 3-D model or 2-D CAD files of the assembly.

4. The method of claim 2, wherein the cleaning step includes removing one or more extraneous elements from the assembly.

5. The method of claim 2, wherein the cleaning step includes applying a baseline texture to all surfaces of a component, with the same texture being applied to multiple component surfaces.

6. The method of claim 2, wherein the organizing step includes:
applying unique names to files representing each component.

7. The method of claim 2, wherein the organizing step includes:
designating one or more components as at least one of: a featured part, an animatable part, and a hideable part.

8. The method of claim 7, wherein the designating step includes:
modifying a filename assigned to each component to apply a common convention related to the applicable designations.

9. The method of claim 2, further comprising:
testing the refined data files in combination with the configuration file.

10. The method of claim 2, further comprising:
additional cleaning of the 3-D data files between the refining step and the building step.

11. The method of claim 2, wherein the refining step includes at least one of smoothing and texturizing.

12. The method of claim 2, wherein the refining step includes at least one of diffuse mapping, normal mapping, and alpha mapping.

13. The method of claim 2, further comprising exporting refined data files into JSON or HTML.

14. The method of claim 1, wherein inputs to examine the assembly or one of its components include at least one of panning, rotating, and exploding.

15. The method of claim 1, wherein the displaying step includes displaying one or more of a component name, one or more unique component identifiers, a description of the component, and purchasing information for a replacement component.

16. The method of claim 1, wherein the ordering step includes:
linking to one or more databases or websites,
verifying availability of the replacement component,
transmitting billing and shipping information, and
completing a purchase transaction.

17. A method for interactive modeling of a 3-D assembly, comprising:
receiving, by a computer, source materials,
cleaning, by a computer, 3-D data files included in or derived from the source materials,
organizing the cleaned-up geometry,
refining the data files,
building a configuration file, and
deploying the refined data files and the configuration file.

18. The method of claim 17, wherein the source materials comprise a 3-D model or 2-D CAD files of the assembly.

19. The method of claim 17, wherein the cleaning step includes removing one or more extraneous elements from the assembly.

20. The method of claim 17, wherein the cleaning step includes applying a baseline texture to all surfaces of a component, with the same texture being applied to multiple component surfaces.

21. The method of claim 17, wherein the organizing step includes:
applying unique names to files representing each component.

22. The method of claim 17, wherein the organizing step includes:
designating one or more components as at least one of: a featured part, an animatable part, and a hideable part.

23. The method of claim 22, wherein the designating step includes:
modifying a filename assigned to each component to apply a common convention related to the applicable designations.

24. The method of claim 17, further comprising:
testing the refined data files in combination with the configuration file.

25. The method of claim 17, further comprising:
additional cleaning of the 3-D data files between the refining step and the building step.

26. The method of claim 17, wherein the refining step includes at least one of smoothing and texturizing.

28. The method of claim 17, wherein the refining step includes at least one of diffuse mapping, normal mapping, and alpha mapping

29. The method of claim 17, further comprising exporting refined data files into JSON or HTML.
